(19) United States
(12) Patent Application Publication
(10) Pub. No.: US 2025/0386822 A1
(43) Pub. Date: Dec. 25, 2025

(54) Microcapsules controlling the diffusion of an active organic compound

(71) Applicant: KAPSERA, BORDEAUX (FR)

(72) Inventors: Wafa BOUHLEL, ANTIBES (FR); Karen CHAITOU, PARIS (FR); Edouard DULIEGE, MONTFORT SUR MEU (FR)

(21) Appl. No.: 18/879,031

(22) PCT Filed: Jun. 29, 2023
(86) PCT No.: PCT/EP2023/067858

§ 371 Date: Dec. 26, 2024

(30) Foreign Application Priority Data
Jun. 30, 2022 (FR) 2206603

(51) Int. Cl. A01N 25/28; A01N 25/04; A01N 63/00; A01P 21/00

(52) U.S. Cl. CPC A01N 25/28; A01N 25/04; A01N 63/00; A01P 21/00

(57) ABSTRACT

A microcapsule with a core including a lipophilic phase surrounded by a gelled shell, and wherein the core further includes at least one active organic compound, the uses of the microcapsule in various fields of application such as crop and/or seed treatment, human and/or animal nutrition, cosmetics and pharmaceuticals, soil and wastewater decontamination, care products, and a method for treating crops and/or seeds.

### CROSS-REFERENCE TO RELATED APPLICATIONS

This application claims benefit under 35 USC § 371 of PCT Application No. PCT/EP2023/067858 entitled MICROCAPSULES CONTROLLING THE DIFFUSION OF AN ACTIVE ORGANIC COMPOUND, filed on Jun. 29, 2023 by inventors Wafa Bouhlel, Karen Chaitou and Edouard Duliege. PCT Application No. PCT/EP2023/067858 claims priority of French Patent Application No. 22 06603, filed on Jun. 30, 2022.

### FIELD OF THE INVENTION

The present invention relates to a microcapsule with a core comprising a lipophilic phase surrounded by a gelled shell, and wherein the core further comprises at least one active organic compound, the uses of the said microcapsule in various fields of application such as crop and/or seed treatment, human and/or animal nutrition, cosmetics and pharmaceuticals, soil and wastewater decontamination, and care products.

### BACKGROUND OF THE INVENTION

Semiochemical compounds are chemical substances emitted by an organism into the environment as a signal to other organisms. They can be emitted by plants or animals as part of interspecific interactions (allelochemical compounds) or intraspecific interactions (pheromones). Among the semiochemical compounds are pheromones. Pheromones are natural substances secreted in the external environment by one individual and received by a second individual of the same species on which they provoke a specific reaction. They are usually an olfactory signal acting as a messenger within a population.

Pheromones can be used to control pest populations by influencing their reproductive behaviour. At present, most pheromone-based biocontrol products used are stored in plastic or other polymeric dispensers (manually attached to trees or plants) which allow the pheromone to diffuse through their walls. Although these dispensers have been effective in controlling certain insects, their application requires a great deal of manual labour and has to be carried out several times a season, making the task tedious. Most existing systems, which include polymer beads, do not last long enough in the field.

For these compounds to be used as an effective biocontrol tool, the pheromones need to diffuse at constant concentrations over relatively long periods, lasting several months, which corresponds to the flight period of the pests. However, current methods are unable to achieve these timescales. The difficulty of developing controlled-release formulations capable of releasing pheromones at a constant rate over a prolonged period has been a factor limiting their use in the control of crop pests. Furthermore, since existing products are mainly devices on which the pheromone is immobilised, they cannot be sprayed.

### SUMMARY OF THE DESCRIPTION

The aim is to enable controlled diffusion of active organic compounds over periods lasting from several weeks to several months. Acquiring this capacity will make it possible to develop a range of products with a variety of properties in response to different agronomic issues.

The pheromones are also fairly expensive, so it is preferable that their use be carefully controlled to limit overuse and optimise their effectiveness. A sprayable form of pheromones would enable large areas to be treated uniformly. The inventors' solution, in addition to enabling the pheromones to be sprayed, allows them to be distributed at a constant speed over a long period.

The invention therefore proposes to encapsulate active organic compounds in a capsule with a core comprising a lipophilic phase in order to meet these objectives.

The encapsulation of organic compounds enables diffusion to be controlled, in particular by influencing the partition coefficient of the compound between the lipophilic phase and the aqueous phase and the geometry of the capsule. This solution can, for example, extend the pheromone diffusion time from less than 10 days to more than 38 days.

In addition, the size of the capsules can be specifically chosen to enable the active agent to be applied by spraying, for example for open-field spraying. The size of these capsules is adapted to the use of standard agricultural equipment.

Thus the invention relates to a microcapsule with a core comprising a lipophilic phase surrounded by a gelled shell wherein the microcapsule has an average diameter of between 50 and 4000 μm when in hydrated form, and wherein the core further comprises at least one active organic compound.

The invention further relates to the use of microcapsules according to the invention for the treatment of plant crops and/or seeds thereof, for animal nutrition and/or diets, for human nutrition and/or diets, for the formulation of cosmetics and/or pharmaceutical compositions, for soil and wastewater decontamination, and for the formulation of care products.

The invention further relates to a method of treating crops and/or seeds comprising the application of microcapsules according to the invention.

### BRIEF DESCRIPTION OF THE DRAWINGS

FIG. 1: This graph represents the abundance of the main compound of the non-encapsulated pheromone after preconcentration using the Solid Phase Micro-Extraction (SPME) technique, separation of the pheromone compounds by gas chromatography and detection by mass spectrometry (GCMS) in a closed temperature-controlled chamber.

FIG. 2: This graph represents the abundance of the main compound of the encapsulated pheromone after preconcentration using the Solid Phase Micro-Extraction (SPME) technique, separation of the pheromone compounds by gas chromatography and detection by mass spectrometry (GCMS) in a closed temperature-controlled chamber.

FIG. 3: This graph represents the abundance of the pheromone peak at equilibrium for different capsule prototypes with continuous phases of different nature.

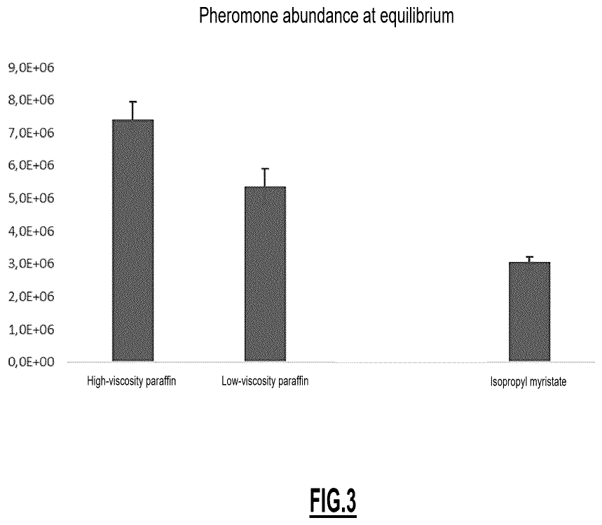

FIG. 4: This graph shows the abundance of the pheromone peak at equilibrium over time, when the pheromone is not encapsulated. The y-axis represents the area under the characteristic peak of the pheromone. The x-axis represents the time of measurement in days (d1, d5) or weeks (S1 to S4).

FIG. 5: This graph shows the abundance of the pheromone peak at equilibrium over time, when the pheromone is encapsulated in a microcapsule with a high-viscosity paraffin core and a shell thickness of 25 μm. The y-axis represents the area under the characteristic peak of the pheromone. The x-axis represents the time of measurement in days (d1, d5) or weeks (S1 to S4).

FIG. 6: This graph shows the abundance of the pheromone peak at equilibrium over time, when the pheromone is encapsulated in a microcapsule with a low-viscosity paraffin core and a shell thickness of 30 μm. The y-axis represents the area under the characteristic peak of the pheromone. The x-axis represents the time of measurement in days (d1, d5) or weeks (S1 to S4).

FIG. 7: This graph shows the abundance of the pheromone peak at equilibrium over time, when the pheromone is encapsulated in a microcapsule with a high-viscosity paraffin core and a shell thickness of 100 μm. The y-axis represents the area under the characteristic peak of the pheromone. The x-axis represents the time of measurement in days (d1, d5) or weeks (S1 to S4).

FIG. 8: This graph shows the abundance of the pheromone peak at equilibrium over time, when the pheromone is encapsulated in a millimetre-scale microcapsule. The y-axis represents the area under the characteristic peak of the pheromone. The x-axis represents the time of measurement in days (d1, d5) or weeks (S1 to S4).

FIG. 9: This graph shows the fraction of pheromone remaining after 4 weeks of diffusion (as a percentage).

FIG. 10: This graph shows the effect of the samples tested on the behaviour of the male insect, and therefore on its response. The words “14 DAO” mean 14 days after opening, meaning that the bottle containing the capsules tested was opened and kept for 14 days in the oven before carrying out the test.

FIG. 11: This graph shows the fraction of pheromone remaining after 20 weeks of diffusion (as a percentage).

FIG. 12: This graph shows the drop in fertility for couples placed close to the samples. The words “14 DAO” mean 14 days after opening, meaning that the bottle containing the capsules tested was opened and kept for 14 days in the oven before carrying out the test.

### DETAILED DESCRIPTION OF EMBODIMENTS

### Microcapsule

“Microcapsule” in this context means a capsule with an average diameter of less than 10 mm and comprising at least a core and a shell. Such capsules preferably comprise a liquid or solid core encapsulated by a substantially solid gelled envelope. The core is preferably liquid. This type of capsule has applications in many technical fields. The shell comprises one or more concentric or non-concentric compartments. Preferably, the microcapsules according to the invention comprise a single core coated by the shell.

These microcapsules are therefore very different from microbeads, as microbeads are mainly made up of a solid or gelled matrix comprising multiple small inclusions.

According to a preferred embodiment of the invention, the microcapsules have a core volume to total microcapsule volume ratio of greater than 20%. These microcapsules thus make it possible to contain a large core volume, and therefore active organic compound volume, for a given volume of shell.

Microcapsules are well known to the skilled person and can be formed by different techniques and have different shell compositions.

Typically, the microcapsules used in the context of the invention are produced according to the manufacturing method described in French patent no. 2939012.

When the microcapsules according to the invention are in a suspension in an aqueous solution, they have an average diameter of between 50 and 4000 μm, preferably between 50 and 2000 μm, more particularly between 50 and 800 μm, advantageously between 100 and 400 μm. This average diameter can be measured by various techniques well known to those skilled in the art, such as granulometry based on the diffraction of laser light, fractionation by sieving, or imaging by optical microscopy. This diameter is particularly suitable for spray application.

Preferably, the microcapsules according to the invention are free, i.e. they are not included in another structure such as a film, a bead, a gel, or encapsulated a second time, but they are in direct contact with the medium surrounding them, typically a liquid (if they are in suspension, for example) or a gas.

### The Core

The core of the microcapsules according to the invention is a core comprising a lipophilic phase, preferably comprising a majority of a lipophilic phase.

Thus the core comprising a lipophilic phase of the microcapsules according to the invention can be an oily core, i.e. composed solely of oil, or alternatively be in the form of an oil-in-water (O/W) emulsion, for example an oil-in-water microemulsion. In such a case, the core of the microcapsule is therefore mainly composed of an oil or an oil mixture, preferably oils of vegetable, mineral or synthetic origin or a mixture thereof. “Oil” means a fatty substance that is liquid at room temperature (25° C.) and atmospheric pressure.

The core comprising a lipophilic phase may also be a core comprising or consisting of fats that are solid at ambient temperature and pressure, in particular chosen from waxes, pasty fats and butters, and mixtures thereof.

In a preferred embodiment, the core is liquid at room temperature, or liquid at a temperature between 15° C. and 30° C.

In one embodiment of the invention, the core does not comprise wax.

The core of the microcapsule is therefore mainly composed of a lipophilic phase. In particular, the core is mainly composed of fatty compounds of animal, vegetable, mineral or synthetic origin, or a mixture of these.

In a preferred embodiment, the core of the microcapsule according to the invention is an oily core comprising an oil chosen from isopropyl myristate, paraffin oil, and mixtures thereof. In a preferred embodiment, the core of the microcapsules according to the invention is an oily core composed mainly of a paraffin oil and mixtures thereof.

In a preferred embodiment, the core comprises one or more elements chosen from: fatty acids (saturated fatty acids such as palmitic acid, mono- and polyunsaturated fatty acids such as linolenic acid), simple lipids (glycerides such as oils and butter and steroids), complex lipids (phospholipids, sphingolipids and glycerol derivatives), and isoprenic lipids (steroids and terpenics).

Preferably, the core composition is biodegradable.

According to a preferred mode of the invention, the viscosity of the core is less than 2000 mPa·s.

The core of the microcapsules according to the invention comprises at least one active organic compound.

“Active organic compound” means an active substance, active principle, or active ingredient that is known and/or used for a particular purpose and of which one of the chemical components is carbon.

Preferably, said at least one active organic compound is a volatile compound.

“Volatile organic compound” means any organic compound, excluding methane, having a vapour pressure greater than or equal to 0.01 kPa at a temperature of 293.15 K (20° C.) or having a corresponding volatility under particular conditions of use (pressure and temperature).

More preferably, the active organic compound according to the invention is a semiochemical compound, which may be volatile.

“Semiochemical compound” or “semiochemical” means an active substance, a chemical substance emitted by an organism into the environment as a signal to other organisms. Preferably, said at least one semiochemical compound of the microcapsule is chosen from pheromones, allomones, kairomones, andsynomones. More specifically, the semiochemicals in the microcapsule can be of natural or chemical origin, i.e. extracted from a living organism or chemically synthesised.

In one embodiment, the at least one semiochemical compound is an oxygenated hydrocarbon with a size of between 10 and 20 carbons, which may be unsaturated and have other functions such as an alcohol, acetate, and/or aldehyde function.

In one embodiment, the semiochemical according to the invention is a sex pheromone. The preferred semiochemical is the sex pheromone of the pest targeted by a biocontrol treatment. In one embodiment, the semiochemical is a sex pheromone of Lobesia botrana (European grapevine moth), Eupoecilia ambiguella (commonly called European grape berry moth), Cydia pomonella (codling moth), Grapholita molesta (Oriental fruit moth), Anarsia lineata (Peach twig borer), Tuta absoluta (Tomato leafminer) or Thaumetopoea pityocampa (Pine processionary).

In one embodiment, the semiochemical according to the invention is a kairomone, for example a kairomone targeting the faba bean beetle.

In one embodiment, the semiochemical is selected from Z-13-hexadecen-11-yn-1-yl acetate, (E)-7-(Z)-9-dodecadienyl acetate (C₁₄H₂₄O₂), and (Z)-9-dodecenyl acetate (C₁₄H₂₆O₂).

In one embodiment, the oily core of the microcapsule has a semiochemical concentration by weight of between 0.1% and 10%, more preferably between 0.2% and 5%.

### The Shell

Microcapsules according to the invention preferably comprise at least one liquid core encapsulated by a substantially solid gelled envelope called the shell.

Preferably, the shell of the microcapsules according to the invention is mainly composed of a biopolymer with gelling properties; this biopolymer that forms a majority of the shell is hereinafter referred to as the main biopolymer. Examples of such biopolymers with gelling properties are alginate, gellan gum, xanthan gum, pectin, chitosan, agar, and carrageenan.

The materials that make up the shell are preferably biodegradable and biosourced. The shell is preferably semi-permeable to gases and low-molecular-weight molecules.

The gels forming the shell can be physical or chemical, i.e. formed by coacervation or polymerisation.

The gelling of these biopolymers can be achieved by a variation in temperature (gellan gum), a variation in pH (chitosan, collagen, pectin) or by ions (alginate, carrageenan).

Preferably, the shell of the microcapsules according to the invention is mainly composed of a biopolymer having gelling properties caused by ionic or temperature variation.

Preferably, the shell of the microcapsules according to the invention is mainly composed of alginate.

The shell may also comprise one or more biopolymers other than the main biopolymer, such as starch (in its various forms, e.g. pregelatinised starch or amylose), potato protein, or a biopolymer other than the main biopolymer having gelling properties, e.g. alginate, gellan gum, xanthan gum, pectin, chitosan, agar, or carrageenan.

Preferably, the shell of the microcapsules according to the invention comprises a gel containing water, one or more biopolymers with gelling properties, and optionally a surfactant resulting from its manufacturing method. Preferably, the shell of the microcapsules according to the invention comprises a gel containing water, alginate, and optionally a surfactant resulting from its manufacturing method.

In a preferred embodiment, the shell of the microcapsules according to the invention does not comprise any polymer other than alginate.

Preferably the alginate is a sodium alginate or a potassium alginate. Alginates are produced from brown algae that are also called seaweed. Such alginates advantageously have an α-L-guluronate content of over 50%, preferably over 55% or even over 60%.

The surfactant is advantageously an anionic surfactant, a non-ionic surfactant, a cationic surfactant or a mixture thereof. The molecular weight of the surfactant is between 150 g/mol and 10,000 g/mol, advantageously between 250 g/mol and 1,500 g/mol.

If the surfactant is an anionic surfactant, it is chosen, for example, from an alkyl sulphate, an alkyl sulphonate, an alkyl aryl sulphonate, an alkaline alkyl phosphate, a dialkyl sulphosuccinate, and an alkaline earth salt of saturated or unsaturated fatty acids. These surfactants advantageously have at least one hydrophobic hydrocarbon chain with a carbon number greater than 5, or even 10, and at least one hydrophilic anionic group, such as a sulphate, sulphonate, or carboxylate linked to one end of the hydrophobic chain. If the surfactant is a cationic surfactant, it is for example chosen from an alkylpyridium or alkylammonium halide salt such as n-ethyldodecylammonium chloride or bromide, cetylammonium chloride or bromide (CTAB). These surfactants advantageously have at least one hydrophobic hydrocarbon chain with a carbon number greater than 5, or even 10, and at least one hydrophilic cationic group, such as a quaternary ammonium cation. If the surfactant is a non-ionic surfactant, it is chosen, for example, from polyoxyethylenated and/or polyoxypropylenated derivatives of fatty alcohols, fatty acids, or alkylphenols, arylphenols, or from alkyl glucosides, polysorbates and cocamides.

In one embodiment, the surfactant is sodium lauryl sulphate (SLS) also known as sodium dodecyl sulphate and/or polyoxyethylene sorbitan monoleate (Polysorbate 80).

Preferably, the surfactant is polyoxyethylene sorbitan monoleate (Polysorbate 80).

In one embodiment, the mass content of surfactant in the shell is greater than 0.001% and advantageously greater than 0.1%. Advantageously, the concentration by mass of surfactant is approximately 0.3%.

The shell of the microcapsules according to the invention may further comprise stabilisers, densifying particles or sedimentation-limiting agents, such as silica or talc.

The thickness of the shell is a factor influencing the robustness of the microcapsule and the diffusion kinetics of the active organic compound. In this way, the thickness of the shell can be chosen to obtain the desired diffusion kinetics. Preferably, the thickness of the shell is at least 10 μm, preferably between 20 μm and 500 μm, more preferably between 20 and 150 μm.

The shell of the microcapsule preferably has a thickness of between 0.1% and 20%, advantageously between 1% and 20%, and more particularly between 10% and 20% of the diameter of the capsule.

The diffusion of the active organic compound is also dependent on the partition coefficient between the lipophilic core of the microcapsule and the aqueous phase of the shell.

Preferably, the microcapsule according to the invention is suitable for diffusing the active organic compound over a period of more than 3 weeks, more preferably more than 6 weeks and most preferably more than 2 months. The invention thus relates to the use, preferably non-therapeutic use, of the microcapsule according to the invention for the diffusion of the active organic compound over a period of more than 3 weeks, more preferably more than 6 weeks and most preferably more than 2 months.

Preferably, the microcapsule according to the invention is adapted to diffuse the active organic compound over a period corresponding to the flight period of the target pest.

If the active organic compound of the microcapsule is a semiochemical and more particularly a sex pheromone of a given flying pest, then the microcapsule is adapted to diffuse said pheromone over the duration of the flight period of the said pest.

“Adapted to diffuse the active organic compound over a period” means that during said period, the active organic compound continues to diffuse out of the microcapsule at a substantially constant non-zero rate.

The microcapsule may also include other components, such as antioxidant compounds, UV filters, pigments, dyes, stabilisers, densifying particles such as silica or talc, essential oils, or other additives.

### Uses and Methods

The definitions laid out in the microcapsule section also apply here.

Preferably, in the methods and uses according to the invention, the microcapsules are used as they are, i.e. they are not included in another structure (such as a film, a bead, a gel, or encapsulated a second time), but rather are used directly, possibly suspended in a liquid.

The invention concerns the use of microcapsules according to the invention for the treatment of plant crops and/or their seeds.

“Treatment of plant crops and/or their seeds” means treatments that can be carried out before, during or after planting, and more specifically with the aim of preventing and/or limiting pest attacks or reducing their impact. It also means treatments that can be applied in green areas, such as gardens or parks. The invention relates in particular to the use of microcapsules according to the invention as a pesticide.

The invention therefore relates in particular to the use of microcapsules for treating plant crops and/or their seeds, wherein the active organic compound is a biocontrol agent.

The invention comprises a method of treating crops and/or seeds comprising the application of microcapsules according to the invention.

“Crop” or “plant production” in this context means plant production derived from working the land. In one embodiment, the crops are chosen from wheat, maize, rape, vines and beetroot.

The invention relates in particular to a method for treating crops and/or seeds comprising spreading, foliar spraying or coating seeds with microcapsules according to the invention, preferably microcapsules according to the invention wherein the active organic compound is a biocontrol agent. In this method, the microcapsules can be used suspended in a liquid.

“Pests” in this context means mainly animal pests, such as insects, arachnids or small mammals, with insects being the most common.

More specifically, the pests are chosen from among Lobesia botrana (European grapevine moth), Eupoecilia ambiguella (commonly called European grape berry moth), Cydia pomonella (codling moth), Grapholita molesta (Oriental fruit moth), Anarsia lineata (Peach twig borer), Tuta absoluta (Tomato leafminer), Thaumetopoea pityocampa (Pine processionary), and Bruchus rufimanus (Bean leaf beetle), as well as aphids, midges, codling moths, corn borers, flea beetles, terminal bud weevils, cryptoblab beetles, and leafhoppers.

“Pesticide” in this context means a formulation designed to eliminate insects, rodents or weeds.

In another embodiment, the invention relates to the use, preferably non-therapeutic, of microcapsules according to the invention for animal and/or human nutrition and/or diets. In this embodiment, the active organic compounds used are preferably not therapeutic active agents, i.e. they are of interest from a nutritional or dietary point of view but they do not make it possible to prevent or treat illnesses in the subject consuming them. Preferably, the active organic compounds used are edible agents, preferably with organoleptic or nutritional properties. In this application, the active agents are preferably of interest from a nutritional or dietary point of view, but do not prevent or treat diseases in the subject consuming them.

“Diet” in this context means the habitual or frequent intake of food. The microcapsules can contain active organic compounds that improve the properties of a food product, such as its organoleptic properties (e.g. by diffusing aromas such as essential oils) or its shelf life (e.g. by controlling the diffusion of the organic compound).

“Nutrition” in this context means taking food supplements, often on an occasional basis or as part of a cure, typically to prevent or make up for a deficiency. The microcapsules according to the invention may contain vitamins, for example.

“Animal” in this context means a wild or domesticated animal. It is preferably a domesticated, farmed or pet animal. In particular, the animals according to the invention are chosen from pets such as dogs, cats, fish, rabbits, horses, tortoises, farmed species such as cattle (cows, oxen), sheep, goats, rabbits, pigs (pig), camels, and birds raised in poultry farming (hens, quails, etc.).

The invention further relates to the use of microcapsules according to the invention for the formulation of cosmetics. In this embodiment, the active organic compounds used are preferably not therapeutic active agents, i.e. they are of interest from a cosmetic point of view but they do not make it possible to prevent or treat illnesses in the subject using them.

Thus, for example, microcapsules according to the invention may comprise conventional adjuvants for cosmetic compositions, such as: Hydrophilic or lipophilic cosmetic active ingredients, preservatives, antioxidants, perfumes and odour-absorbing agents.

The invention further relates to the use of microcapsules according to the invention for the formulation of pharmaceutical compositions. In this embodiment, the active agents used are preferably therapeutic active agents, i.e. they make it possible to prevent or treat illnesses in the subject consuming them.

The use of microcapsules in accordance with the invention makes it easier to store, package or prepare cosmetic or pharmaceutical formulations, while keeping the active organic compound in good quality.

### Pharmaceutical Compositions and Therapeutic Applications

The invention further relates to a pharmaceutical composition comprising a microcapsule according to the invention. The application further relates to a microcapsule according to the invention for use as a medication.

The present invention further relates to a method of treating a subject, comprising administering a therapeutically effective amount of microcapsules according to the invention to a subject in need thereof.

In this embodiment, the microcapsule according to the invention advantageously comprises a therapeutically active compound.

“Therapeutically active agent” in this context means an active agent as defined in the microcapsule section above which in addition is known and/or used for a particular therapeutic purpose, i.e. it is known and/or used in the treatment or prevention of diseases.

“Pharmaceutical compositions” means compositions with curative or preventive properties in respect of human or animaldiseases. In particular, the capsules according to the invention may comprise insect-repellent semiochemicals, making it possible to prevent or limit the arrival of parasites on animals or humans.

Pharmaceutical compositions as defined herein therefore preferably also comprise pharmaceutically acceptable excipients.

“Pharmaceutically acceptable” in this context refers to compositions and molecular entities that do not produce side effects, allergic reactions, or otherwise undesirable reactions when administered to a subject.

“Subject” in this context means a living being, preferably a mammal, and more particularly a human being.

“Therapeutically effective quantity” in this context means a quantity that is effective at the doses and for the periods required to obtain the desired therapeutic result. This amount may vary depending on factors such as the disease, the extent of the disease, the age, sex and weight of the subject, and the ability of the microcapsules to produce a desired therapeutic result. A therapeutically effective quantity is one in which any toxic or harmful effects are offset by therapeutically beneficial effects. A therapeutically effective quantity also encompasses a quantity sufficient to confer a benefit, for example a clinical benefit.

Such pharmaceutical compositions are preferably adapted to the route of administration.

In a particular embodiment, the pharmaceutical compositions are suitable for oral, sublingual, buccal, intranasal, or topical administration.

The invention further relates to the use of microcapsules according to the invention for manufacturing a medication. The invention further relates to the use of microcapsules according to the invention for the formulation of pharmaceutical compositions.

For these uses, the microcapsule according to the invention advantageously comprises a therapeutic active agent.

“Treatment” or “treating” in this context means partially or substantially achieving one or more of the following results: Partially or totally reducing the extent of the disease; improving a clinical symptom or an indicator associated with the disease; delaying, inhibiting or preventing the progression of the disease.

“Prevention” or “preventing” in this context means partially or substantially achieving one or more of the following results: Preventing or delaying the onset of the disease or at least one of its symptoms, preventing or delaying the deterioration of an indicator associated with the onset of the disease.

The invention further relates to the use of microcapsules according to the invention for soil or wastewater decontamination.

The invention further relates to the use of microcapsules according to the invention in care products. “Care products” means products for use in a private or professional setting to maintain, clean and/or protect surfaces.

The invention thus concerns the use of microcapsules according to the invention in the formulation of care products, for example:
in pesticides, insecticides, and insect repellents for indoor and outdoor use,
in air fresheners, for example textile air fresheners or home fragrances,
in wood care products, for example to limit wood attack by parasites.

In the description and in the following examples, unless otherwise indicated, percentages are percentages by weight and ranges of values are expressed as “between . . . and . . . ”, “from . . . to . . . ” or “greater than . . . ” include the specified limits.

Throughout the application, the wording “comprising one” or “including one” means “comprising at least one” or “including at least one” unless otherwise specified.

The following examples are given by way of illustration and are not intended to limit the scope of the invention.

### EXAMPLES

### Example 1

Capsules were formed by co-extrusion of two fluids:
the core fluid consists of paraffin oil in which the pheromone is solubilised at a concentration of 1% by weight, and
the shell fluid consisting of a solution of alginate and a surfactant (SDS at a molar concentration of 8 mM).

The respective fluid flow rates between the core and shell fluids and the piezoelectric actuation parameters (voltage and frequency) applied to the co-flow were optimised in order to ultimately obtain monodisperse, single-core, core-shell capsules of calibrated size, with a homogeneous alginate shell in order to handle a homogeneous sample and be able to characterise the diffusion phenomenon in a reproducible way.

The study was carried out on the pine processionary pheromone, Z-13-hexadecen-11-yn-1-yl acetate. This compound, like all pheromones, is relatively expensive (€300/g). One of the inventors' first efforts was to develop a method for injecting small core volumes of the order of a mL.

A segmented injection system proved satisfactory. The sample containing the pheromone was placed between two small air bubbles separating it from the carrier oil.

An analytical method was developed to detect the pheromone's main compound. The low quantities of analytes led to the choice of a pre-concentration method known as Solid Phase Micro-Extraction (SPME) and Gas Chromatography-Mass Spectrometry (GCMS).

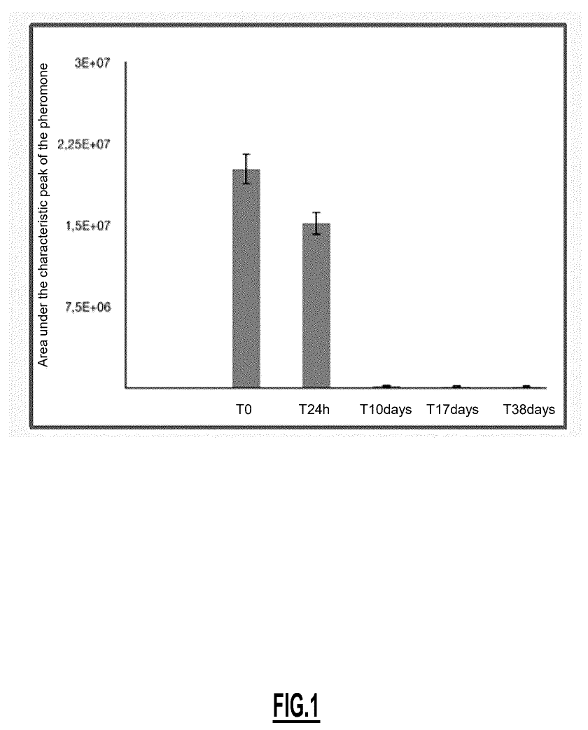

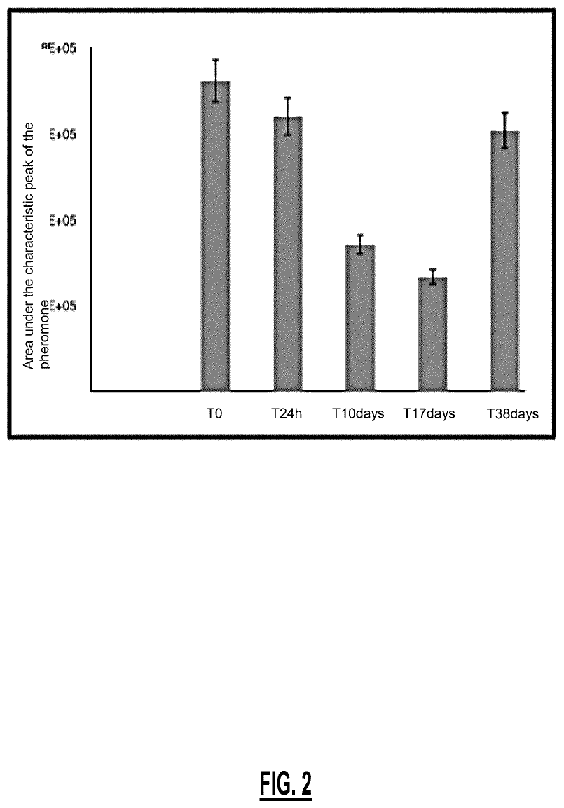

The inventors ensured that the pheromone not only diffused out of the capsules, but also that the encapsulation significantly extended the duration of the pheromone's diffusion, from less than 10 days to more than 38 days (see FIGS. 1 and 2).

### Example 2: Closed System: Study of Thermodynamic Equilibrium

In order to establish the diffusion profiles of the samples at short times and to obtain initial information on any differences between the capsules, a study was carried out in a closed system.

The experiment consists of introducing the samples into 20 mL hermetically sealed flasks and following the evolution of the quantity extracted by the SPME fibre over time, until equilibrium is reached. Measurements were initially taken over short periods (one measurement every 45 minutes, corresponding to the analysis time) and then, once the maximum concentration had been reached, measurements were taken at longer intervals to ensure that equilibrium had been reached (one measurement every 2.5 hours).

These tests were carried out using the European grapevine moth pheromone, (E)-7-(Z)-9-dodecadienyl acetate (C₁₄H₂₄O₂).

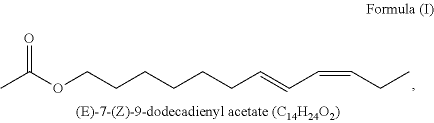 [SMILES: CC/C=C\C=C\CCCCCCOC(C)=O]

### a) Effect of Encapsulation

The inventors observed that when the pheromone is encapsulated, equilibrium is reached after about two hours, whereas when it is not encapsulated, equilibrium is not reached even after 50 hours, which means that the pheromone continues to be released. It would therefore seem that the presence of the alginate membrane has an effect on the thermodynamic equilibrium of the system when the pheromone is confined.

### b) Effect of Core Composition

The amount of pheromone adsorbed on the fibre also varies according to the composition of the microcapsule core. The inventors tested three oils as the core composition of the microcapsule: Isopropyl myristate and two paraffin oils with different compositions and viscosities.

The inventors have observed that the quantities of pheromones released at equilibrium for paraffins are greater than for isopropyl myristate. In particular, the amount of pheromone released at equilibrium is two to three times greater for paraffins than for isopropyl myristate. This suggests that the pheromone is retained to a greater or lesser extent depending on the nature of the core solution in which it is dispersed.

The structure of the volatile compound (particularly in terms of chain length and functional group) is closer to that of isopropyl myristate than to that of paraffins. The inventors have therefore hypothesised that when the volatile compound has more affinity with the continuous phase, its diffusion out from the capsule is slowed down.

### c) Effect of Shell Thickness

The inventors also compared capsules with a shell thickness of 25 μm to capsules with a shell thickness of 100 μm. The results obtained seem to indicate that if there is an effect of the variation in shell thickness, it is relatively weak or barely visible under these analysis conditions. Nevertheless, a trend has taken shape: As the thickness of the shell increases, diffusion seems to slow down slightly.

### d) Effect of Capsule Size

The inventors compared sub-millimetre capsules with millimetre capsules. Here they observed a visible slowdown in diffusion in the case of millimetre-scale capsules. This can be explained by the larger exchange surface in the case of submillimetre-scale capsules, for a given quantity of pheromone.

To conclude this example, encapsulating the pheromone has a benefit. It appears that encapsulation has an effect on thermodynamics and modifies the diffusion equilibrium. This modification depends on the chemical nature of the shell and therefore on the solubility of the molecule of interest in it; this parameter is represented by the partition coefficient K, which is recognised for its ability to describe the equilibrium of a molecule between the 2 phases of a two-phase system made up of two immiscible solvents.

The K coefficient also depends on the solubility of the molecule of interest in the continuous phase (core solution) and therefore on the affinity between the two. This explains the variations observed between the different continuous phases.

The thickness of the shell defines the surface over which the gradient is established and gives the flow. In theory, the larger the surface area, the longer it will take for the molecule to be released.

Finally, as mentioned previously, the differences obtained between submillimetre-scale and millimetre-scale capsules can be explained by the exchange surface, which is greater for a submillimetre-scale capsule sample than for a millimetre-scale capsule sample, both of which contain the same quantities of pheromone.

### Example 3: Open System, Kinetic Study Under “Real-World” Conditions

The experiment involves releasing the pheromone into a ventilated oven at a controlled temperature (17° C.) and monitoring changes in the quantity of pheromone remaining in the sample over time. After a pre-defined extraction and equilibration time, the abundance of the extracted pheromone is measured. The quantity extracted is proportional to the mass of pheromone remaining in the capsules. In practice, for each prototype, the wet capsules are placed at the bottom of hermetically sealed bottles of defined volume (20 mL) dedicated to SPME analysis. Before each analysis, the vials are closed for 3 hours on a Peltier rack at 17° C. to ensure that the measurements are carried out once equilibrium has been established.

Diffusion monitoring took place over 20 weeks.

The capsules in this example are produced in a similar way to example 1.

This example was carried out for grapevine worms: European grapevine moth and European berry moth.

The main molecules in the sex pheromones of these two species are (E)-7-(Z)-9-dodecadienyl acetate (C₁₄H₂₄O₂, shown above) and (Z)-9-dodecenyl acetate (C₁₄H₂₆O₂).

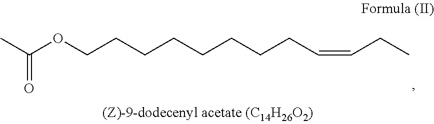 [SMILES: CC/C=C\CCCCCCCCOC(C)=O]

Three oils were tested: Isopropyl myristate and two paraffin oils with different compositions and viscosities.

Finally, the analysis of pheromone diffusion through the capsule shell (in this case the alginate membrane) was carried out by GC/MS, always including a sample pre-concentration step using the SPME technique. The inventors were thus able to monitor the release kinetics of several capsule samples and that of a non-encapsulated control (in which the pheromone was simply solubilised in paraffin oil).

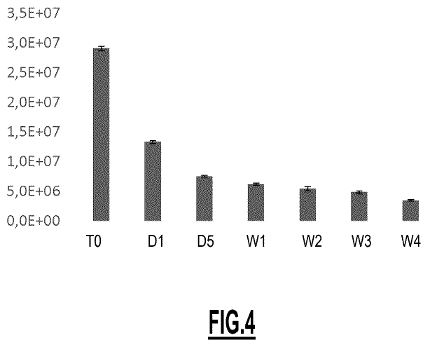

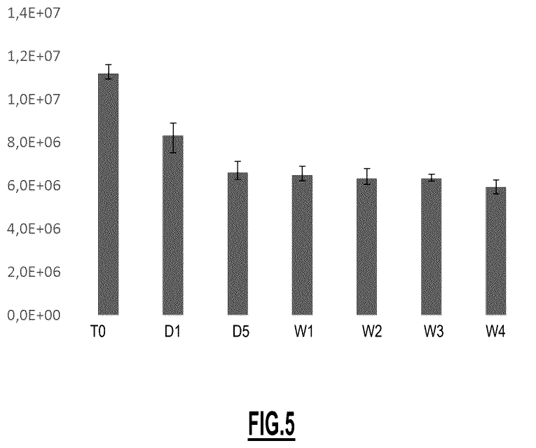

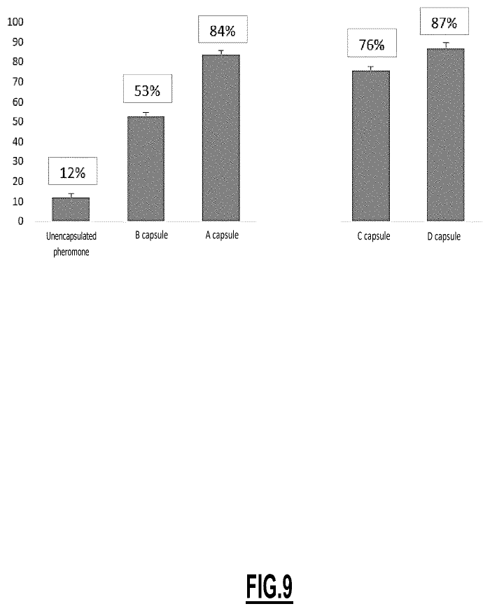

The inventors demonstrated the benefits of formulating pheromones in alginate capsules. The results (FIGS. 4 and 5) show that encapsulation slows down the release of the pheromone and therefore increases the time during which it diffuses out of the capsules: After 4 weeks of diffusion, 88% of the initial quantity of pheromone was released when the pheromone was not encapsulated, compared with only 47% in the encapsulated form (FIG. 9).

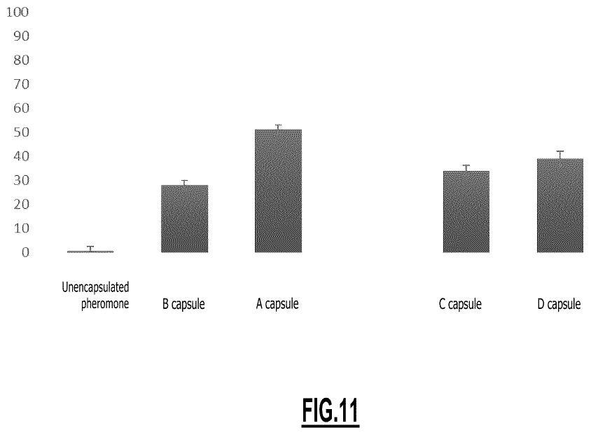

After 20 weeks of diffusion, the inventors observed that 99.5% (9.95 mg) of the initial quantity of pheromone was released when it was not encapsulated, compared with only 72% for the encapsulated form (FIG. 11). The capsules shown in FIG. 4 have an average diameter of 495 μm with a shell thickness of 25 μm (e=25 μm) and an oily paraffin core (here paraffin 1), hereinafter referred to as B capsules. For a given core phase, the inventors have also varied the geometry of the capsule, i.e. the size of the capsule and the thickness of the alginate membrane.

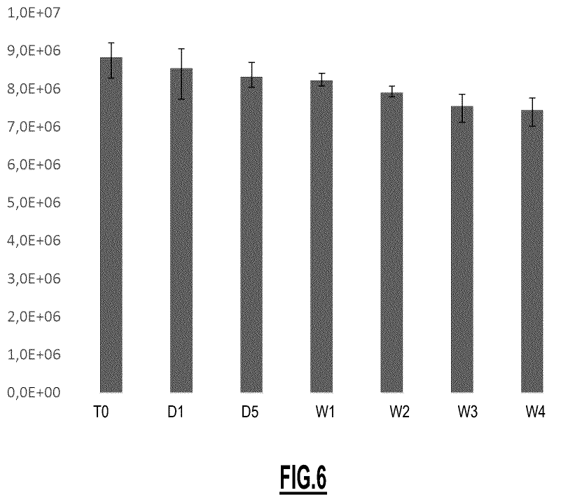

By varying these parameters, it is possible to obtain different diffusion profiles (FIGS. 6, 7 and 8).

In FIG. 6, 490 μm diameter capsules with a 30 μm shell thickness and a low-viscosity paraffin core are tested (A capsules).

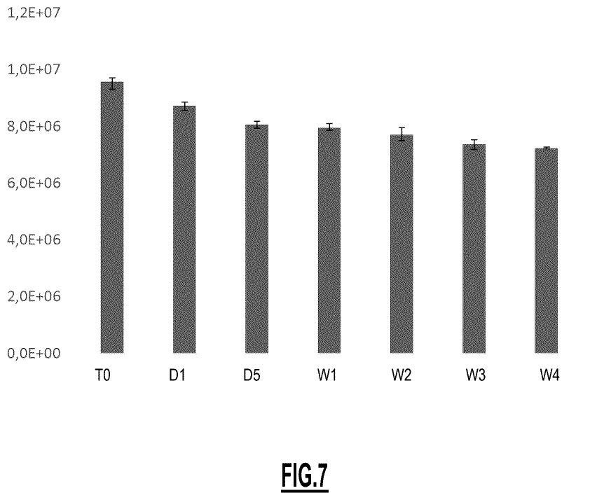

In FIG. 7, 505 μm diameter capsules with a 100 μm shell thickness and a high-viscosity paraffin core are tested.

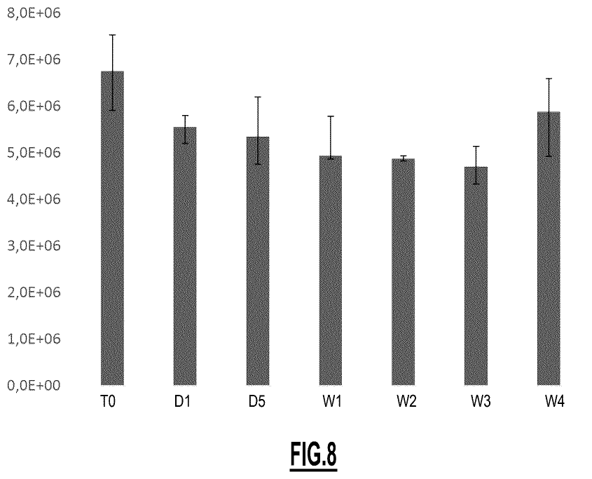

In FIG. 8, 4 mm diameter capsules with a 310 μm shell thickness and a high-viscosity paraffin core are tested (D capsules).

The characteristics of the capsules produced and on which the diffusion phenomenon was studied are presented in the following table:

TABLE 1

| Name | A capsule | | B capsule | | C capsule | | D capsule | |
|---|---|---|---|---|---|---|---|---|
| Composition of | Low-viscosity | | High-viscosity | | High-viscosity | | High-viscosity | |
| the core | paraffin wax | | paraffin wax | | paraffin wax | | paraffin wax | |
| Qₜₒₜ: Total flow | 320 | ml/h | 320 | ml/h | 360 | ml/h | 40 | ml/h |
| R_{q}: Core-shell | 1 | | 1 | | 0.1 | | 1 | |
| ratio | | | | | | | | |
| Average | 490 | μm | 495 | μm | 505 | μm | 4 | mm |
| diameter | | | | | | | | |
| Shell thickness | 30 | μm | 25 | μm | 100 | μm | 310 | μm |
| Coefficient of | 2% | | 2% | | 3% | | 1% | |
| variation of | | | | | | | | |
| average | | | | | | | | |
| diameter | | | | | | | | |

Upon comparing the pheromone fractions remaining after four weeks of diffusion for the capsule prototypes studied (FIG. 9), the inventors drew two conclusions:
The affinity of pheromones for the continuous phase (oil phase) is the most important thermodynamic factor in controlling their diffusion.
Capsule geometry (size and thickness of the alginate membrane) appears to have an effect on release kinetics.
   Several observations can be made by plotting the pheromone release curves over time for each of the samples studied.

The first is that, depending on the sample, the release of the pheromone is more or less linear. For the non-encapsulated pheromone, this release is not linear. The same applies to high-viscosity paraffin capsules (membrane thickness of 25 μm). In contrast, for low viscosity paraffin capsules with a membrane thickness of 25 μm, high viscosity paraffin capsules with a membrane thickness of 100 μm and millimetre capsules, pheromone release was fairly linear, with coefficients of determination (R²) of 0.97, 0.95 and 0.94 respectively.

Upon comparing the slopes of these linear regressions, the inventors found that the slope obtained for the non-encapsulated pheromone is at least three times greater than that obtained when the pheromone is encapsulated.

Upon comparing the slopes of the straight lines obtained for high-viscosity paraffin capsules with membrane thicknesses of 25 and 100 μm, the inventors observed fairly similar values, which suggests that the thickness of the membrane does not have a significant effect on the diffusion phenomenon.

Finally, when comparing submillimetre- and millimetre-scale capsules for the same core phase (high-viscosity paraffin) and the same core/shell ratio (Rq=1), the inventors observed that the slope is half as steep when the capsule is larger. This is due to the larger exchange surface in the case of submillimetre-scale capsules. This trend is also observed when comparing submillimetre-scale capsules with different core phases: the slope is twice as steep for capsules with high-viscosity paraffin than for capsules with low-viscosity paraffin.

In conclusion, the parameter that most influences the phenomenon of diffusion is the nature of the core phase and the affinity and solubility that the pheromone has with it; and secondly, the geometric parameters of the capsules.

The inventors have demonstrated the benefits of formulating pheromones in capsules with a core comprising a lipophilic phase. They were also able to characterise the diffusion process fairly precisely and deduce the parameters that have a significant influence on it.

### Example 4: Tests on Insects

The capsules in this example are produced in a similar way to example 3.

To test the effect of the capsules on the insects, trials were carried out in a flight tunnel. The tunnel was an enclosure 150 cm long, 50 cm wide and 32 cm high, with a fan at both ends of the tunnel in which the incoming air is filtered (carbon filter). The inventors are studying the diffusion of the chemical signal by a flow of air from its source to the receiver (a male insect, Lobesia botrana). During the tests, the lighting was red, with an intensity of 80 lux; the temperature was 21° C.; the relative humidity was 80%; and the wind speed was set at 0.35 m/s. The male was released 140 cm from the source, on a stand at a height of 30 cm. The male's behaviour was measured on a predefined scale for 2 min. The source contains 220 mg of pheromone. A positive control and a commercial product were also tested under the same conditions. The positive control was a commercial control from BIOPROX comprising 1 mg of pheromone embedded in rubber. The commercial product was a pheromone-diffusing rak (plastic dispenser).

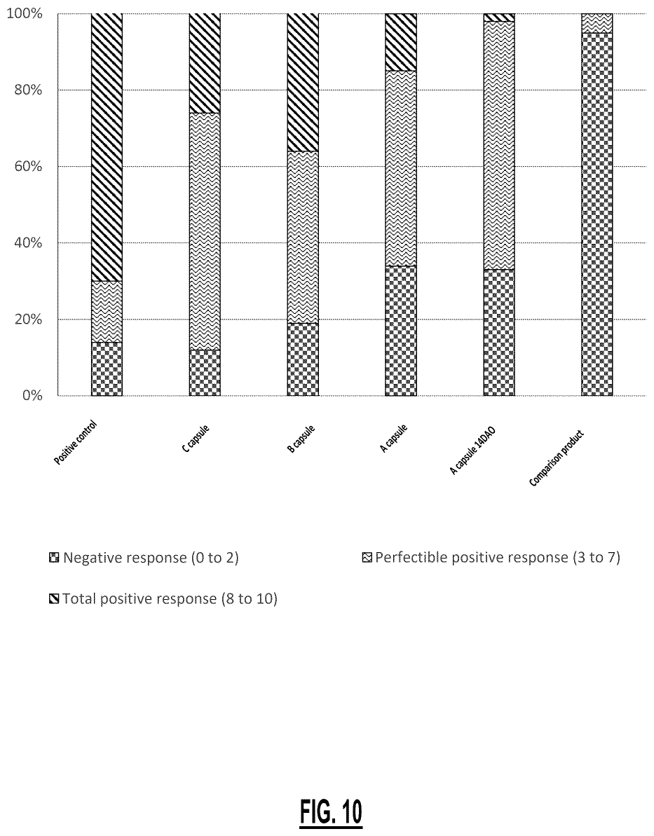

The results obtained are shown in FIG. 10. The words “14 DAO” mean 14 days after opening, meaning that the bottle containing the capsules tested was opened and kept for 14 days in the oven before carrying out the test.

Thanks to this test, the inventors have shown that the parameters that have the greatest influence on the observed behaviour of the male are the thickness of the capsule shell and the composition of the core in relation to the ageing of the capsules.

### Example 5

The outdoor effect of the microcapsules was also tested. Microcapsules were deposited in an orchard and three cages are placed nearby, each cage containing five Lobesia botrana couples. The inventors then measured the egg-laying rate of the females after a night spent in a cage in this environment.

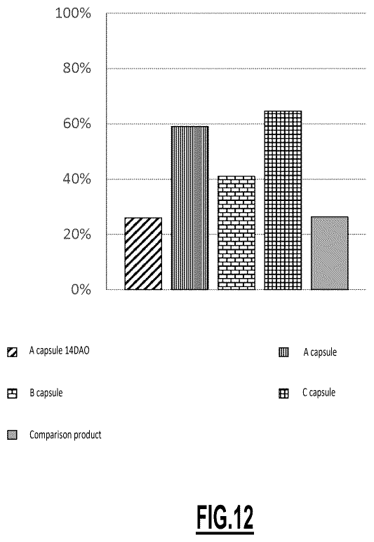

These tests made it possible to validate the microcapsules according to the invention for outdoor use (see results in FIG. 12).

Thanks to these tests, the inventors have shown that the parameters that have the greatest influence on the reproduction of Lobesia botrana are, in order of importance, the ageing of the capsules, the composition of the core, and the thickness of the shell.

1. A microcapsule with a core comprising:
a lipophilic phase surrounded by a gelled shell wherein the microcapsule has an average diameter of between 50 and 4000 μm when in hydrated form; and
at least one semiochemical compound.

2. The microcapsule according to claim 1, wherein the core is oily or is an oil-in-water emulsion.

3. The microcapsule according to claim 1, wherein said at least one semiochemical compound is chosen from pheromones, allomones, kairomones, and synomones.

4. The microcapsule according to claim 1, wherein said at least one semiochemical compound is volatile.

5. The microcapsule according to claim 1, wherein the gelled shell has a thickness of at least 10 μm.

6. The microcapsule according to claim 2, wherein the oily core is composed mainly of an oil chosen from paraffins and mixtures thereof.

7. The microcapsule according to claim 1, for use in the diffusion of said at least one semiochemical compound over a period of more than 3 weeks.

8. A use of microcapsules according to claim 1 for the treatment of plant crops and/or their seeds.

9. A method for treating crops and/or seeds comprising the applying of microcapsules according to claim 1.

10. The use of microcapsules according to claim 1 for animal and/or human nutrition and/or diets.

11. The use of microcapsules according to claim 1 for the formulation of pharmaceutical compositions.

12. The use of microcapsules according to claim 1 for soil or wastewater decontamination.

13. The use of microcapsules according to claim 1 in care products.

14. The microcapsule according to claim 1 for its use for animal and/or human nutrition and/or diets.

15. The microcapsule according to claim 1 for its use as a medication.
